(19) United States
(12) Patent Application Publication
(10) Pub. No.: US 2012/0318744 A1
(43) Pub. Date: Dec. 20, 2012

(54) METAL ADSORBENT AND A METHOD FOR PRODUCING IT, AND A METAL CAPTURING METHOD USING THE METAL ADSORBENT

(76) Inventors: Hongjuan MA, Gunma (JP); Hiroyuki HOSHINA, Gunma (JP); Noriaki SEKO, Gunma (JP)

(21) Appl. No.: 13/525,418

(22) Filed: Jun. 18, 2012

(30) Foreign Application Priority Data
Jun. 20, 2011 (JP) 2011-136812
May 9, 2012 (JP) 2012-108003

(51) Int. Cl. B01J 20/26; C08F 2/46; B01D 15/08; C08F 120/32

(52) U.S. Cl. 210/688; 525/327.3; 522/189; 210/681

(57) ABSTRACT

The present invention is one capable of collecting the metal dissolving in a solution, wherein graft chains of a glycidylalkyl(meth)acrylate represented by the following general formula (1) are formed in the polymer substrate and the graft chain has an amino group or a sulfonic acid group:

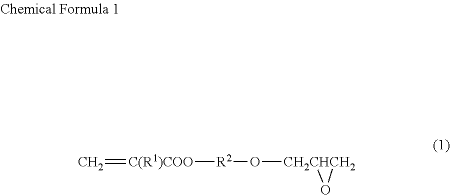

(In the general formula (1), R¹ represents a hydrogen atom or a methyl group; R² represents a linear or branched alkylene group having from 4 to 10 carbon atoms.)

### TECHNICAL FIELD

The present invention relates to a metal adsorbent and a method for producing it, and a metal capturing method using the metal adsorbent.

### BACKGROUND ART

A lot of metal adsorbents for capturing the metal dissolving in a solution have heretofore been proposed. For example, the present applicant has proposed a metal adsorbent prepared by introducing glycidyl methacrylate graft chains into a polymer substrate followed by introducing an amino group into the graft chain (see Patent Reference 1).

### CITATION LIST

### Patent Reference

Patent Reference 1 JP-A 2005-154973

### SUMMARY OF THE INVENTION

### Problems that the Invention is to Solve

The above-mentioned metal adsorbent has an excellent adsorbability to such an extent that it can collect the metals such as gold, platinum, palladium, silver and the like dissolving in a solution in an amount of at least 95% of all the metals in the solution.

To that effect, it is important to develop a metal adsorbent capable of almost completely collecting specific metals in a solution, but on the other hand, it is also important to develop a metal adsorbent capable of collecting metals with high efficiency, for example, collecting metals within a shorter period of time. In addition, it is also important to develop a metal adsorbent capable of collecting any other metal than the above-mentioned metals. This is because the types of the metals to be adsorbed and collected could increase and, in addition, the metal adsorbent suitable for collecting the intended metals to be adsorbed could be selected.

Given the situation as above, the present invention has an object to provide a metal adsorbent capable of capturing the metal dissolving in a solution and a method for producing it, and a metal capturing method using the metal adsorbent.

### Means for Solving the Problems

For solving the above-mentioned problems, the metal adsorbent of the invention is one capable of collecting the metal dissolving in a solution, wherein graft chains of a glycidylalkyl(meth)acrylate represented by the following general formula (1) are formed in the polymer substrate and the graft chain has an amino group or a sulfonic acid group:

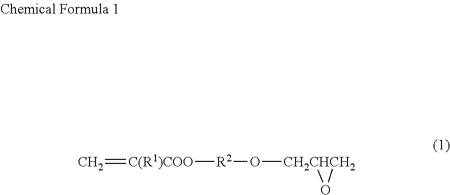

(In the general formula (1), R¹ represents a hydrogen atom or a methyl group; R² represents a linear or branched alkylene group having from 4 to 10 carbon atoms.)

In the metal adsorbent, preferably, a crosslinked structure is given to the graft chain.

In the metal adsorbent, preferably, the glycidylalkyl(meth)acrylate represented by the general formula (1) is 4-hydroxybutyl acrylate glycidyl ether.

The method for producing a metal adsorbent of the invention is a method for producing a metal adsorbent for capturing the metal dissolving in a solution, which comprises graft-polymerizing a glycidylalkyl(meth)acrylate represented by the following general formula (2) with a polymer substrate, and introducing an amino group or a sulfonic acid group into the graft chain formed through the graft polymerization.

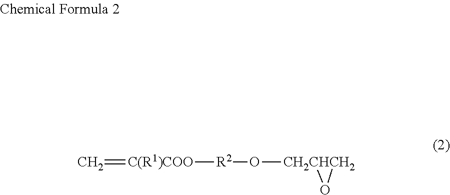

(In the general formula (2), R¹ represents a hydrogen atom or a methyl group; R² represents a linear or branched alkylene group having from 4 to 10 carbon atoms.)

In the method for producing a metal adsorbent, preferably, the polymer substrate is irradiated with radiation before introduction of the amino group or the sulfonic acid group into the graft chain, thereby imparting a crosslinked structure to the graft chain.

In the method for producing a metal adsorbent, preferably, the polymer substrate is irradiated with radiation after introduction of the amino group or the sulfonic acid group into the graft chain, thereby imparting a crosslinked structure to the graft chain.

Further preferably in the method for producing a metal adsorbent, after the amino group or the sulfonic acid group has been introduced into the graft chain, a metal-dissolved solution is led to run through the polymer substrate so that the metal is adsorbed by the substrate, then the substrate is irradiated with radiation to thereby impart a crosslinked structure to the graft chain therein, and thereafter an eluate is led to run through the substrate to thereby elute the adsorbed metal.

In the method for producing a metal adsorbent, preferably, the glycidylalkyl(meth)acrylate represented by the general formula (2) is 4-hydroxybutyl acrylate glycidyl ether.

In the method for producing a metal adsorbent, preferably, the impartation of the crosslinked structure is attained through irradiation of the polymer substrate with radiation in the co-presence of a solvent.

In the method for producing a metal adsorbent, preferably, the solvent is an aqueous solvent.

In the method for producing the metal adsorbent, preferably, the impartation of the crosslinked structure is attained through irradiation of the polymer substrate with radiation in the presence of a crosslinking agent.

In the method for producing the metal adsorbent, preferably, the crosslinking agent is a polyfunctional vinyl monomer.

The metal capturing method of the invention comprises applying a solution with a metal dissolving therein to the metal adsorbent to thereby capture the metal from the solution.

In the metal capturing method, preferably, a solution with at least one metal selected from lead, copper, zinc, nickel and lithium dissolving therein is led to run through the metal adsorbent with sulfonic acid group-having graft chains formed therein, thereby capturing the metal from the solution.

In the metal capturing method, preferably, a solution with at least one metal selected from lead, copper, zinc and nickel dissolving therein is led to run through the metal adsorbent with amino group-having graft chains formed therein, thereby capturing the metal from the solution.

Further preferably in the metal capturing method, the solution with at least copper dissolving therein is led to run through the metal adsorbent having a crosslinked structure given to the graft chain therein, thereby selectively capturing copper from the solution.

### Advantage of the Invention

According to the invention, there is obtained a metal adsorbent capable of capturing the metal dissolving in a solution.

### BRIEF DESCRIPTION OF THE DRAWINGS

FIG. 1 This is a view showing the copper adsorbability of an adsorbent 4HB-EDA and an adsorbent GMA-EDA.

FIG. 2 This is a view showing the copper and lead adsorbability of an adsorbent 4HB-EDA given a crosslinked structure.

FIG. 3 This shows the results of the influence of the electron beam irradiation condition on a polymer substrate.

FIG. 4 This shows the results of the influence of the electron beam irradiation condition on an adsorbent 4HB-EDA.

FIG. 5 (a) is a view showing the adsorbability for various types of metals of an adsorbent 4HB-EDA; and (b) is a view showing the adsorbability for various types of metals of an SO3H-type adsorbent.

FIG. 6 This is a view showing the copper and lead adsorbability of an adsorbent 4HB-EDA given a crosslinked structure through electron beam irradiation in the co-presence of methanol (with no crosslinking agent).

FIG. 7 This is a view showing the copper and lead adsorbability of an adsorbent 4HB-EDA given a crosslinked structure through electron beam irradiation in the co-presence of DVB-added methanol.

FIG. 8 This is a view showing the copper and lead adsorbability of an adsorbent 4HB-EDA given a crosslinked structure through electron beam irradiation in the co-presence of TAIC-added methanol.

### MODE FOR CARRYING OUT THE INVENTION

In the metal adsorbent of one embodiment of the invention graft chains of a glycidylalkyl(meth)acrylate represented by the above-mentioned general formula (1) are formed in the polymer substrate, and the graft chain has an amino group or a sulfonic acid group as mentioned below. In this, the graft chain may be given a crosslinked structure. Embodiments of the method for producing the metal adsorbent are described below.

The metal adsorbent of one embodiment of the invention can be produced by graft-polymerizing, as a reactive monomer, a glycidylalkyl(meth)acrylate represented by the above-mentioned general formula (1) with a polymer substrate, and introducing an amino group or a sulfonic acid group into the graft chain formed through the graft polymerization.

The polymer substrate to be used in this embodiment may be formed of, for example, polyolefinic fibers of polyethylene, polypropylene or the like. The polymer substrate may be in the form of an aggregate of fibers, such as a woven fabric, a nonwoven fabric, a hollow fiber membrane or the like. The nonwoven fabric is preferred since the porosity thereof may be increased and since it enables high-speed water treatment.

In graft-polymerizing the reactive monomer with the polymer substrate, the polymer substrate is previously activated. “Activation” means forming reaction-active points for graft polymerization of the reactive monomer with the polymer substrate. The polymer substrate may be activated, for example, by irradiating the polymer substrate that has been previously purged with nitrogen, with radiation in a nitrogen atmosphere at room temperature or with cooling. The radiation to be used may be an electron beam or γ-ray, and the radiation dose may be one enough to form the reaction-active points. For example, the dose may be from 1 to 200 kGy or so, preferably from 20 to 100 kGy.

After the polymer substrate has been activated, a reactive monomer is brought into contact with the polymer substrate for the intended graft polymerization.

As the reactive polymer, usable is an epoxy-terminated (meth)acrylate. Concretely, used here is a glycidylalkyl (meth)acrylate represented by the general formula (1) as mentioned above. In the general formula (1), R² is a linear or branched alkylene group having from 4 to 10 carbon atoms, and therefore, the glycidylalkyl(meth)acrylate of the formula is characterized in that the side chain thereof is long as compared with that of the glycidyl methacrylate used as the reactive monomer in producing the metal adsorbent in Patent Reference 1. The metal adsorbent of the embodiment of the invention, which is produced by using the glycidylalkyl(meth)acrylate of the general formula (1) as the reactive monomer can rapidly adsorb the metal such as copper or the like existing in a solution, as compared with the metal adsorbent in Patent Reference 1 which is produced by using glycidyl methacrylate as the reactive monomer. This is presumed because the contact efficiency of the amino group or the sulfonic acid group introduced into the graft chain and the metal in the solution could be enhanced by the effect of the length of the side chain of the reactive monomer.

Specific examples of the glycidylalkyl (meth)acrylate represented by the general formula (1) include 4-hydroxybutyl acrylate glycidyl ether, 5-hydroxypentyl acrylate glycidyl ether, 6-hydroxyhexyl acrylate glycidyl ether, 7-hydroxyheptyl acrylate glycidyl ether, 8-hydroxyoctyl acrylate glycidyl ether, 9-hydroxynonyl acrylate glycidyl ether, 10-hydroxydecyl acrylate glycidyl ether, etc., and methacrylates corresponding thereto. For more effectively realizing the intended effect of the invention, R² in the general formula (1) is preferably an alkylene group having from 4 to 6 carbon atoms. The glycidylalkyl(meth)acrylate represented by the general formula (1) may be produced according to a known method. In addition, the compound may be available as commercial products.

The solution containing the reactive monomer includes two types, a water-based emulsion system, and an organic solvent-based non-emulsion system. Of those, preferred is use of the emulsion system having good reaction efficiency.

The emulsion system comprises the reactive monomer, a surfactant and an aqueous solvent, and is a system where small droplets of the reactive monomer insoluble in water are dispersed in the aqueous solvent in the presence of the surfactant. The size of the small droplets of the reactive monomer is not specifically defined; and the solution may include a microemulsion having a size of from 1 μm to 900 μm or so, and a nanoemulsion having a size of from 1 nm to 900 nm.

As the surfactant, usable here are an anionic surfactant, a cationic surfactant, an ampholytic surfactant, a nonionic surfactant, etc. One or more different types of surfactants may be used here either singly or as combined. The anionic surfactant includes alkylbenzene surfactants, alcohol surfactants, olefinic surfactants, phosphate surfactants, amide surfactants, etc.; and concretely mentioned is sodium dodecylsulfate. The cationic surfactant includes octadecylamine acetate salts, trimethylammonium chloride, etc. The nonionic surfactant includes ethoxylated fatty alcohols, aliphatic acid esters, etc.; and concretely mentioned are polyoxyethylene(20) sorbitan monolaurate (Tween 20), sorbitan monolaurate (Span-20), etc. As the ampholytic surfactant, for example, there may be mentioned Amphitol® (by Kao).

The concentration of the surfactant to be used is not specifically defined, and may be suitably determined depending on the type and the concentration of the reactive monomer. The concentration of the surfactant is preferably from 0.1 to 10% by weight based on the total weight of the solvent.

The aqueous solvent includes, for example, distilled water, ion-exchanged water, pure water, ultrapure water, etc. Using the aqueous solvent solves the problem of waste liquid treatment and contributes toward environmental protection.

The non-emulsion system comprises the reactive monomer and an organic solvent. Not specifically defined, the organic solvent includes, for example, alcohol such as methanol, etc.; mixed solvent of alcohol and water, etc.

After the graft chain has been formed through the graft polymerization, an amino group or a sulfonic acid group is introduced into the graft chain. The amino group or the sulfonic acid group introduced into the graft chain forms a chelate with the metal dissolving in a solution, and therefore the polymer substrate with such a functional group introduced into the graft chain therein acts as a metal adsorbent.

In this embodiment, the amino group includes a primary amino group (—NH2), a secondary amino group (—NHR), and a tertiary amino group (—NRR′) (where R and R′ each are the same or a different hydrocarbon group). By reacting an amine such as trimethylamine, dimethylamine, methylamine, ammonia, ethylenediamine, diethanolamine or the like with the glycidyl group of the graft chain, the amino group can be introduced into the graft chain.

In this embodiment, for introducing a sulfonic acid group (—SO3H) (hereinafter this may be referred to as an H-type) into the graft chain, for example, an inexpensive reagent, alkali metal sulfate such as sodium sulfate salt or the like is used for sulfonation, and the sulfonic acid base (—SO3X) (where X is an alkali metal such as sodium, potassium, etc.) is introduced into the graft chain, and then acid-processed with nitric acid, sulfuric acid or the like to convert it into an H-type group.

A solution with a metal dissolving therein is led to run through the polymer substrate in which an amino group or a sulfonic acid group has been introduced into the graft chain, whereby the metal in the solution can be captured. In the polymer substrate in this embodiment, graft chains of a glycidylalkyl (meth)acrylate represented by the above-mentioned general formula (1) are formed, and therefore, the metal can be captured within a shorter period of time. The reason why the metal can be captured within a shorter period of time is because the functional group (adsorbent group) can be introduced into the surface of the substrate, which is especially effective for the contact reaction, at a high density through the graft polymerization as compared with ordinary chemical polymerization,

The intended metal to be captured includes lead, copper, zinc, nickel, lithium, etc. For example, a solution with at least one metal selected from a group consisting of lead, copper, zinc, nickel and lithium dissolving therein is led to run through the polymer substrate, whereby the metal in the solution can be captured.

The polymer substrate with a sulfonic acid group introduced into the graft chain therein can capture a metal with high adsorptivity. The polymer substrate with a sulfonic acid group introduced into the graft chain therein and the polymer substrate with an amino group introduced into the graft chain therein are compared with each other in point of the metal adsorptivity thereof, and the polymer substrate with a sulfonic acid group introduced into the graft chain therein exhibits a dramatically increased adsorptivity for zinc, nickel and lithium of the above-mentioned metals, especially for nickel and lithium.

In this embodiment, the polymer substrate may be irradiated with radiation to thereby impart a crosslinked structure (hereinafter the “crosslinked structure” may be referred to as “network structure”) to the graft chain therein. In this, the crosslinked structure is formed through irradiation of the polymer substrate with radiation, through which reaction-active points such as radicals or the like are formed in the polymer substrate or on the graft chains, and the crosslinked structure is formed by bonding of the polymer chains or the graft chains to each other through the reaction between the thus-formed reaction-active points. Accordingly, not only the crosslinked structure is formed between the graft chains through the bonding of the graft chains to each other, but also the crosslinked structure may be formed between the polymer chains of the polymer substrate and between the polymer chains and the graft chains of the polymer substrate, by bonding of the polymer chains of the polymer substrate to each other, and by bonding of the polymer chains and the graft chains of the polymer substrate to each other.

The radiation to be used may be an electron beam or γ-ray, like the radiation used for the activation of the polymer substrate mentioned above. The radiation dose may be, for example, from 1 to 600 kGy or so, preferably from 100 to 500 kGy, more preferably from 200 to 500 kGy. Through irradiation at a higher dose, the crosslinked structure can be imparted more effectively. When a radiation at a dose falling within the range is radiated to the polymer substrate, for example, at from room temperature to 350° C. in vacuum or in the presence of an inert gas or oxygen, then a crosslinked structure can be imparted to the graft chains. Preferably, the polymer substrate is dipped in a solvent, and is irradiated with radiation in the co-presence of the solvent. The method of irradiating the polymer substrate in the co-presence of a solvent is preferable since a crosslinked structure can be effectively imparted. The solvent includes water, alcohols such as methanol, etc., to which, however, the invention is not limited. Water is preferably used as inexpensive and easily available.

The impartation of the crosslinked structure to the graft chains may be attained (1) before introduction of an amino group or a sulfonic acid group into the graft chains, or (2) after introduction of an amino group or a sulfonic acid group into the graft chains.

In the case (1), graft chains are formed in the polymer substrate, and then the polymer substrate is irradiated with radiation to thereby impart a crosslinked structure to the graft chain therein, and thereafter an amino group or a sulfonic acid group is introduced into the graft chain.

In the case (2), graft chains are formed in the polymer substrate, and then an amino group or a sulfonic acid group is introduced into the graft chain therein, and thereafter the polymer substrate is irradiated with radiation to thereby impart a crosslinked structure to the graft chain.

Though the reason is not clear, imparting a crosslinked structure to the graft chains can enhance the adsorption selectivity for the metal dissolving in a solution. For example, when a solution with copper and lead co-dissolving therein is led to run through the polymer substrate in which a crosslinked structure has been imparted to the graft chain, then the lead adsorptivity of the substrate becomes at most 10% and the copper adsorptivity thereof becomes 100%, or that is, the copper selective adsorptivity of the substrate is thereby enhanced. In irradiation with radiation for imparting the crosslinked structure, the irradiation dose may be increased or the radiation may be radiated in the co-presence of a solvent to thereby increase the network structures to be formed in the substrate, whereby the metal selectivity of the adsorbent can be controlled.

In the case (2), the crosslinked structure may be imparted while a metal is kept adsorbed by the graft chains. For example, graft chains are formed in the polymer substrate, then an amino group or a sulfonic acid group is introduced into the graft chain, then a metal-dissolved solution is led to run through the polymer substrate to thereby make the metal adsorbed by the substrate, and then the substrate is irradiated with radiation to thereby impart a crosslinked structure to the graft chain therein. In this, the metal to be adsorbed is one capable of forming a chelate with the amino group or the sulfonic acid group introduced into the graft chain, and for this, the intended metal to be adsorbed by the polymer substrate (metal adsorbent) to be obtained finally here is selected. For example, the metal includes the above-mentioned metals such as lead, copper, zinc, nickel, lithium, etc. Accordingly, as the metal-dissolved solution, used here is a solution with a metal suitably selected from those metals dissolving therein.

After the crosslinked structure has been imparted to the graft chain in a condition where the graft chain has adsorbed a metal, an eluate of an acidic solution such as hydrochloric acid or the like is led to run through the substrate to thereby eluate the adsorbed metal. Accordingly, a polymer substrate to which a molecular recognition structure has been imparted is obtained. The metal capturing capability (selectivity) of the polymer substrate to which the molecular recognition structure has been imparted can be enhanced.

In this embodiment, the polymer substrate may be irradiated with radiation in the presence of a crosslinking agent to thereby impart a crosslinked structure. The crosslinking agent is an additive capable of effectively promoting the crosslinking reaction even at a relatively low dose. In this embodiment, the crosslinked structure is given by the use of such a crosslinking agent to thereby further improve the metal selectivity of the adsorbent. In irradiation of the polymer substrate with radiation, the crosslinking agent of the type is used together with a solvent, for example, by adding it to the above-mentioned solvent. As a preferred example of the crosslinking agent, there may be mentioned a polyfunctional vinyl monomer. Specific examples of the monomer include divinylbenzene (DVB), triallyl isocyanurate (TAIC), triallyl trimellitate, divinyl sulfide, divinyl sulfone, etc., to which, however, the invention is not limited. DVB and TAIC are relatively easily available and are preferred for use herein in point of their ability to improve the metal selectivity of adsorbent.

The invention is described in more detail with reference to the following Examples. Needless-to-say, the invention is not limited by the following Examples.

### EXAMPLES

### Example 1

A polyethylene-made nonwoven fabric was used as a polymer substrate. The polymer substrate was irradiated with electron means at 30 kGy with cooling with dry ice in a nitrogen atmosphere, and then reacted in an aqueous 4-hydroxybutyl acrylate glycidyl ether (4HB) solution having a 4HB concentration of 5% and a Span-20(surfactant) concentration of 0.5% for 2 hours, thereby preparing a graft polymer material having graft chains of 4HB therein. Next, the graft polymer material was processed for conversion reaction for 4 hours in an ethylenediamine (EDA) solution comprising 70% EDA and 30% isopropyl alcohol (IPA) so as to introduce the amino group into the graft chains, thereby preparing a 4HB-EDA adsorbent.

On the other hand, a polyethylene-made nonwoven fabric was used as a polymer substrate, and under the same condition as above, this was irradiated with radiation, then reacted for 20 minutes in an aqueous glycidyl methacrylate (GMA) solution having a GMA concentration of 5% and a Span-20 (surfactant) concentration of 0.5%, thereby preparing a graft polymer material having GMA graft chains therein. Next, the graft polymer material was processed for conversion reaction for 4 hours in an EDA solution comprising 70% EDA and 30% IPA (isopropyl alcohol), thereby preparing a GMA-EDA adsorbent.

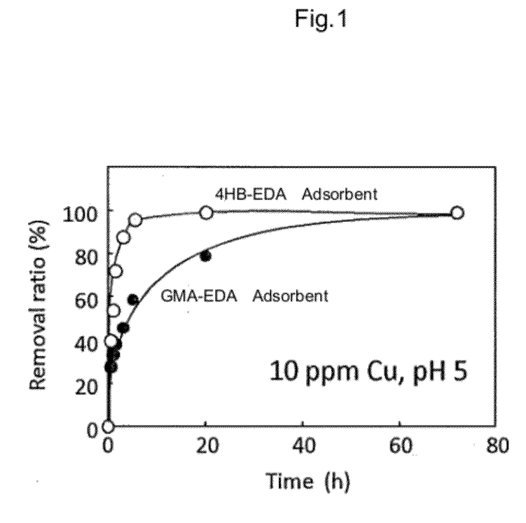

In 45 ml of a copper solution (having a copper concentration of 10 ppm (mg/L), pH 5), the two types of the adsorbents (0.02 g) obtained in the above were dipped, and then the remaining copper concentration in the copper solution was measured to compute the copper adsorptivity, thereby evaluating the copper adsorbability of the adsorbents. The results are shown in FIG. 1.

The horizontal axis of FIG. 1 indicates the adsorption time, and the vertical axis thereof indicates the adsorptivity (removal ratio). In the drawing, “◯” shows the results with the 4HB-EDA adsorbent, and “” shows the results with the GMA-EDA adsorbent. From FIG. 1, it is known that the copper adsorptivity of the GMA-EDA adsorbent in the adsorption time of 5 minutes was about 60%, while the 4HB-EDA adsorbent adsorbed almost all the copper in the copper solution. Accordingly, it is known that, as compared with that of the GMA-EDA adsorbent, the copper adsorption speed of the 4HB-EDA adsorbent is higher.

### Example 2

The 4HB-EDA adsorbent produced in Example 1 was dipped in a 10-ppm copper solution (pH 5) for 5 hours to adsorb the copper, and then irradiated with electron beams at 500 kGy in the co-presence of water to thereby impart a crosslinked structure thereto.

Next, the adsorbent was dipped in a 10 mM EDTA-2Na solution for 30 minutes so that the copper in the adsorbent was eluted, and then this was washed with water to give a metal adsorbent.

The metal adsorbent was dipped in a copper/lead mixed solution (10 ppm copper, 10 ppm lead, pH 5) for 5 hours for the adsorption test thereof, which confirmed the copper adsorbability of the adsorbent.

### Example 3

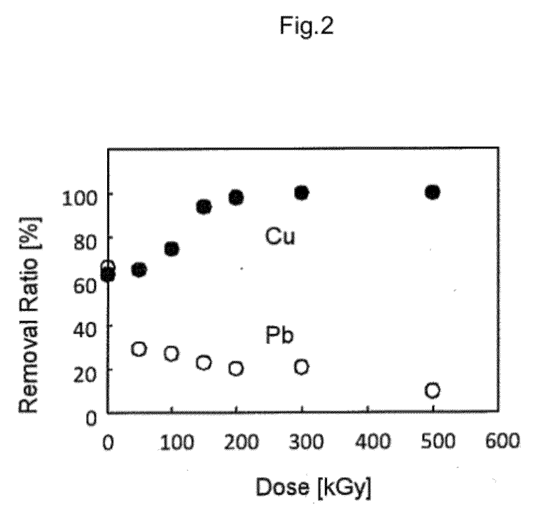

The 4HB-EDA adsorbent produced in Example 1 was irradiated with electron beams at a different dose in the co-presence of water, thereby preparing metal adsorbents having a crosslinked structure imparted thereto. The metal adsorbents irradiated with electron beams at a different dose were dipped in a copper/lead mixed solution (10 ppm copper, 10 ppm lead, pH 5) for 5 hours for the adsorption test thereof. The results are shown in FIG. 2.

The horizontal axis of FIG. 2 indicates the electron beam irradiation dose, and the vertical axis thereof indicates the adsorptivity (removal ratio). In the drawing, “” shows the results for copper, and “◯” shows the results for lead. From FIG. 2, it is known that the adsorbent not given a crosslinked structure (dose: 0 kGy) exhibited the adsorbability on the same level for both copper and lead, or that is, the adsorbent did not have selectivity for copper and lead; but on the other hand, the adsorbent given a crosslinked structure exhibited a difference between copper and lead in the adsorptivity thereof. The lead adsorptivity of the adsorbent, which had been given a crosslinked structure through irradiation with electron beams at 500 kGy, was less than 10%, while the copper adsorptivity thereof was about 100%; or in other words, the result means that the adsorbent adsorbed all the copper in the copper/lead mixed solution but almost lead was kept remaining in the solution. From the result, it has been confirmed that when the adsorbent is made to have a crosslinked structure therein, then the metal selectivity of the adsorbent can be enhanced. In addition, it has also been confirmed that, with the increase in the radiation dose, the metal selectivity of the adsorbent increases.

### Example 4

The same adsorption test as in Example 3 was carried out, except that methanol was made to co-exist in place of the co-presence of water in the system. As a result, the improvement of the metal selectivity of the adsorbent has been confirmed like in Example 3.

### Example 5

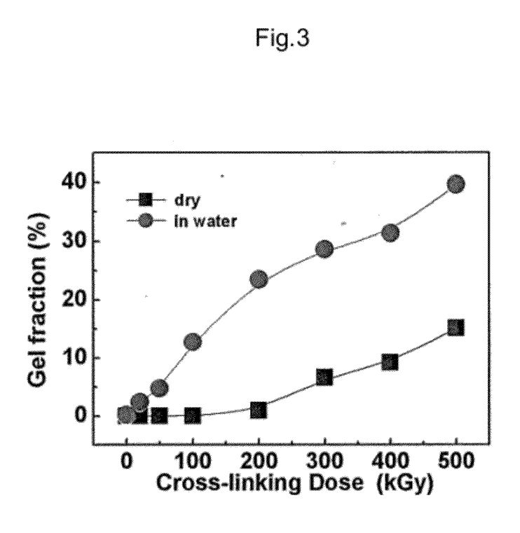

A polymer substrate composed of nonwoven fibers of PE(polyethylene)/PP(polypropylene) was irradiated with electron beams at a different dose in an air atmosphere or while dipped in water (in the co-presence of water). The gel fraction of the polymer substrates thus irradiated with electron beams at a different dose was measured to thereby confirm the influence of the electron beam irradiation condition on the gel fraction. The results are shown in FIG. 3. The gel fraction was measured as follows: The polymer substrate irradiated with electron beams was refluxed in xylene for 24 hours, and the weight of the residue was measured. The ratio of the residue weight to the original weight (the weight of the electron beam-irradiated adsorbent before processed for refluxing) was computed to determine the intended gel fraction.

The horizontal axis of FIG. 3 indicates the electron beam irradiation dose (crosslinking dose), and the vertical axis thereof indicates the gel fraction. In the drawing, “▪” shows the results with the polymer substrate irradiated with electron beams in an air atmosphere; and “” shows the results with the polymer substrate irradiated with electron beams in the co-presence of water. With the increase in the gel fraction, the network structure formed through the crosslinking reaction increases. As in FIG. 3, the polymer substrate irradiated with electron beams in the co-presence of water has a higher gel fraction than that of the polymer substrate irradiated with electron beams in an air atmosphere. This confirms that irradiation with electron beams in the co-presence of water can more effectively impart a crosslinked structure to the adsorbent.

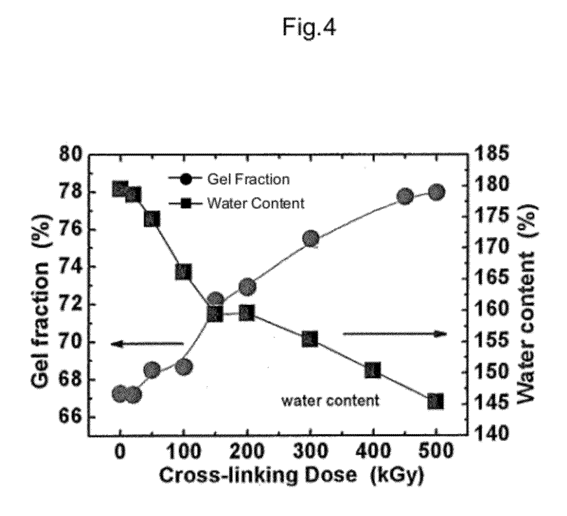

In addition, the 4HB-EDA adsorbent produced in Example 1 was, while kept dipped in water, irradiated with electron beams at a different dose, and the gel fraction and the water content of the adsorbent thus electron-irradiated at a different dose were measured. The results are shown in FIG. 4. The gel fraction measured as follows: The adsorbent irradiated with electron beams was refluxed in xylene for 24 hours, and the weight of the residue was measured. The ratio of the residue weight to the original weight (the weight of the electron beam-irradiated adsorbent before processed for refluxing) was computed to determine the intended gel fraction. The water content was measured as follows: The weight of the absolutely-dried adsorbent (dry weight) was previously measured, and then the adsorbent was dipped in water (pure water). After dipped, the adsorbent was rubbed to remove water, and the weight of the wet adsorbent was measured. The ratio of the wet weight to the dry weight was computed to determine the water content.

The horizontal axis of FIG. 4 indicates the electron beam irradiation dose (crosslinking dose), and the vertical axis thereof indicates the gel fraction and the water content. In the drawing, “” shows the data of the gel fraction; and “570 ” shows the data of the water content. From FIG. 4, it is known that with the increase in the irradiation dose, the gel fraction increases and the water content decreases. This means that, with the increase in the irradiation dose, the network structure formed in the 4HB-EDA adsorbent increased. This confirms that, by increasing the irradiation dose, the crosslinked structure in the adsorbent can be effectively increased.

In consideration of the results of Example 3, it has been confirmed that, by increasing the irradiation dose, the network structure can be increased and the metal selectivity of the adsorbent can be thereby enhanced. It has also been confirmed that, when the electron beam irradiation is attained in the co-presence of water, then the effect can be enhanced even more.

### Example 6

A polyethylene-made nonwoven fabric was used as a polymer substrate. The polymer substrate was irradiated with electron means at 30 kGy with cooling with dry ice in a nitrogen atmosphere, and then reacted in an aqueous 4-hydroxybutyl acrylate glycidyl ether (4HB) solution having a 4HB concentration of 5% and a Span-20(surfactant) concentration of 0.5% for 2 hours, thereby preparing a graft polymer material having graft chains of 4HB therein. Next, the graft polymer material was reacted in a sodium sulfate solution (sodium sulfate/IPA/water=10/15/75) for 5 hours at 80° C. so as to introduce the sulfonic acid base into the graft chains, thereby preparing an SO3Na-type adsorbent. Next, this was treated with sulfuric acid to give an SO3H-type adsorbent (having a sulfonic acid group introduced into the graft chain therein).

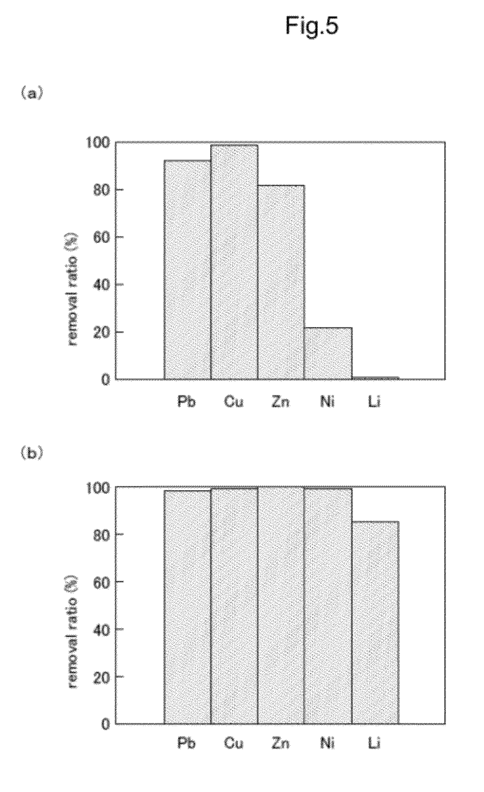

Two adsorbents, the 4HB-EDA adsorbent produced in Example 1 and the SO3H-type adsorbent were tested in an adsorption test, in which the adsorbents were evaluated for the adsorbability thereof for lead, copper, zinc, nickel and lithium. The adsorption test was as follows: Two metal solutions having a metal concentration of 10 ppm were prepared for every metal, and the adsorbents were separately dipped in these solutions. The adsorbability of the 4HB-EDA adsorbent was evaluated as follows: The adsorbent was dipped in the metal solution for 5 hours, and then the remaining metal concentration in the metal solution was measured, and the metal adsorptivity was thereby computed. The SO3H-type adsorbent was evaluated as follows: The adsorbent was dipped in the metal solution for 30 minutes, and then the remaining metal concentration in the metal solution was measured, and the metal adsorptivity was thereby computed. FIG. 5 shows the results.

FIG. 5(a) shows the adsorbability for various types of metals of the 4HB-EDA adsorbent; and FIG. 5(b) shows the adsorbability for various types of metals of the SO3H-type adsorbent. The vertical axis in FIGS. 5(a) and 5(b) indicates the adsorptivity (removal ratio). As in FIG. 5(a), the adsorptivity for lead, copper and zinc of the 4HB-EDA adsorbent was more than 80%, and the adsorptivity for nickel thereof was about 20%. As in FIG. 5(b), the adsorptivity of the SO3H-type adsorbent was more than 80% for every metal; and as compared with the data in FIG. 5(a), the increase in the adsorptivity for zinc, nickel and lithium, especially for nickel and lithium of the SO3H-type adsorbent was great. This confirms that the polymer substrate having a sulfonic acid group introduced into the graft chain therein has excellent adsorbability for lead, copper, zinc, nickel and lithium. In FIG. 5(b), the data measured for 30 minutes for adsorption are shown; and when these are compared with the data in FIG. 5(a) measured for 5 hours for adsorption, it is known that the adsorptivity for each metal of the adsorbent in FIG. 5(b) is higher. This confirms that the adsorption speed with the SO3H-type adsorbent is higher than that with the 4HB-EDA adsorbent.

### Example 7

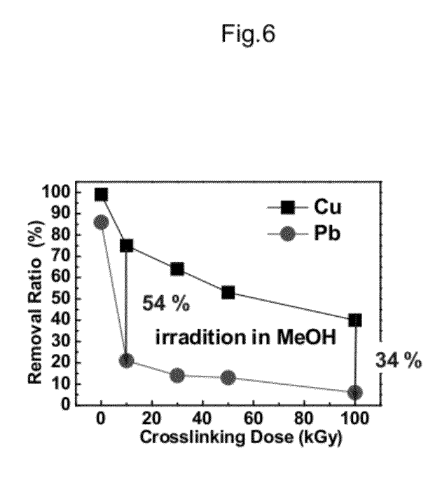

The 4HB-EDA adsorbent produced in Example 1 was irradiated with electron beams at a different dose in the co-presence of methanol (with no crosslinking agent), thereby preparing metal adsorbents having a crosslinked structure imparted thereto. In addition, the 4HB-EDA adsorbent produced in Example 1 was irradiated with electron beams at a different dose in the co-presence of methanol with DVB or TAIC added thereto as a crosslinking agent, thereby preparing metal adsorbents having a crosslinked structure imparted thereto. The metal adsorbents each were dipped in a copper/lead mixed solution (10 ppm copper, 10 ppm lead, pH 5) for 5 hours for the adsorption test thereof. The results are shown in FIGS. 6 to 8.

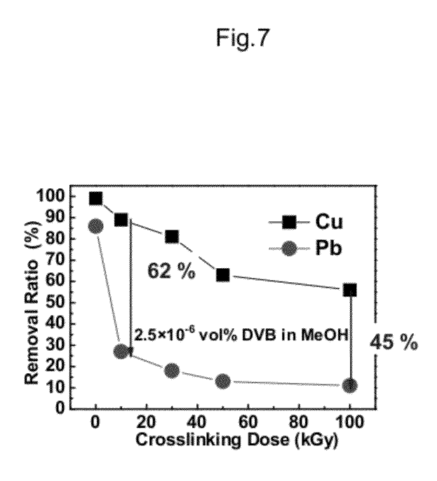

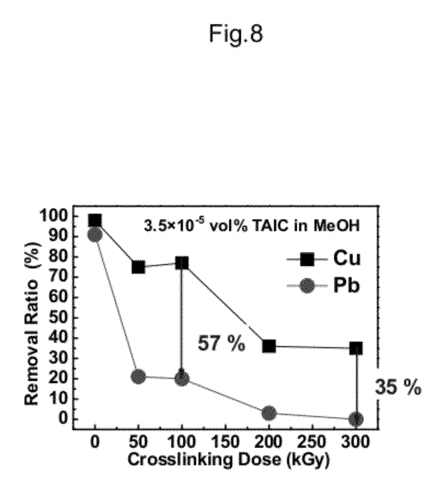

FIG. 6 shows the results of the metal adsorbents each given a crosslinked structure through irradiation with electron beams in the co-presence of methanol (with no crosslinking agent). FIG. 7 shows the results of the metal adsorbents each given a crosslinked structure through irradiation with electron beams in the co-presence of methanol having a DVB concentration of 2.5×10⁻⁶ vol %. FIG. 8 shows the results of the metal adsorbents each given a crosslinked structure through irradiation with electron beams in the co-presence of methanol having a TAIC concentration of 3.5×10⁻⁵ vol %. In each drawing, the horizontal axis indicates the electron beam irradiation dose, and the vertical axis indicates the adsorptivity.

From the results in FIGS. 6-8, it has been confirmed that the adsorbent before given a crosslinked structure (dose: 0 kGy) shows the adsorbability on the same level for both copper and lead, or that is, the adsorbent has no adsorption selectivity between copper and lead. On the other hand, there is seen a difference in the adsorbability for copper and lead among the adsorbents given a crosslinked structure through electron beam irradiation, or that is, the adsorbents have been confirmed to have metal selectivity in adsorption.

The adsorbents given a crosslinked structure through irradiation with electron beams at 10 kGy and 100 kGy were analyzed for the copper adsorptivity and the lead adsorptivity with reference to FIG. 6 and FIG. 7, and it is known that all the adsorbents showed larger values in FIG. 7 than in FIG. 6. The difference between the copper adsorptivity and the lead adsorptivity of the adsorbents given a crosslinked structure through irradiation with electron beams at 100 kGy is checked on FIGS. 6-8, and it is known that the data in FIG. 7 and FIG. 8 are larger than in FIG. 6. Further, from the results in FIG. 8, it is known that the adsorbents given a crosslinked structure through irradiation with electron beams at 200 kGy and at 300 kGy have good adsorbability for copper, but the adsorbability for lead thereof is 5% or less and is low. From these results, it has been confirmed that the metal selectivity of the adsorbents given a crosslinked structure is increased. In addition, it has also been confirmed that when the adsorbents are given a crosslinked structure using a crosslinking agent, the metal selectivity of the resulting adsorbents is increased more.

1. A metal adsorbent capable of collecting the metal dissolving in a solution, wherein graft chains of a glycidylalkyl(meth)acrylate represented by the following general formula (1) are formed in the polymer substrate and the graft chain has an amino group or a sulfonic acid group: 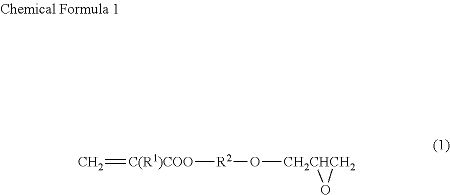
(In the general formula (1), R¹ represents a hydrogen atom or a methyl group; R² represents a linear or branched alkylene group having from 4 to 10 carbon atoms.)

2. The metal adsorbent as claimed in claim 1, wherein a crosslinked structure is given to the graft chain.

3. The metal adsorbent as claimed in claim 1, wherein the glycidylalkyl(meth)acrylate represented by the general formula (1) is 4-hydroxybutyl acrylate glycidyl ether.

4. A method for producing a metal adsorbent for capturing the metal dissolving in a solution, which comprises graft-polymerizing a glycidylalkyl(meth)acrylate represented by the following general formula (2) with a polymer substrate, and introducing an amino group or a sulfonic acid group into the graft chain formed through the graft polymerization 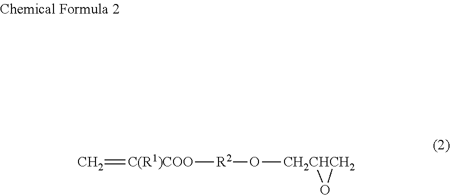
(In the general formula (2), R¹ represents a hydrogen atom or a methyl group; R² represents a linear or branched alkylene group having from 4 to 10 carbon atoms.)

5. The method for producing a metal adsorbent as claimed in claim 4, wherein the polymer substrate is irradiated with radiation before introduction of the amino group or the sulfonic acid group into the graft chain, thereby imparting a crosslinked structure to the graft chain.

6. The method for producing a metal adsorbent as claimed in claim 4, wherein the polymer substrate is irradiated with radiation after introduction of the amino group or the sulfonic acid group into the graft chain, thereby imparting a crosslinked structure to the graft chain.

7. The method for producing a metal adsorbent as claimed in claim 4, wherein after the amino group or the sulfonic acid group has been introduced into the graft chain, a metal-dissolved solution is led to run through the polymer substrate so that the metal is adsorbed by the substrate, then the substrate is irradiated with radiation to thereby impart a crosslinked structure to the graft chain therein, and thereafter an eluate is led to run through the substrate to thereby elute the adsorbed metal.

8. The method for producing a metal adsorbent as claimed in claim 4, wherein the glycidylalkyl(meth)acrylate represented by the general formula (2) is 4-hydroxybutyl acrylate glycidyl ether.

9. The method for producing a metal adsorbent as claimed in claim 4, wherein the impartation of the crosslinked structure is attained through irradiation of the polymer substrate with radiation in the co-presence of a solvent.

10. The method for producing a metal adsorbent as claimed in claim 9, wherein the solvent is an aqueous solvent.

11. The method for producing a metal adsorbent as claimed in claim 4, wherein the crosslinked structure is given through irradiation of the polymer substrate with radiation in the presence of a crosslinking agent.

12. The method for producing a metal adsorbent as claimed in claim 11, wherein the crosslinking agent is a polyfunctional vinyl monomer.

13. A metal capturing method, which comprises applying a solution with a metal dissolving therein to the metal adsorbent of claim 1 to thereby capture the metal from the solution.

14. The metal capturing method as claimed in claim 13, wherein a solution with at least one metal selected from lead, copper, zinc, nickel and lithium dissolving therein is led to run through the metal adsorbent with sulfonic acid group-having graft chains formed therein, thereby capturing the metal from the solution.

15. The metal capturing method as claimed in claim 13, wherein a solution with at least one metal selected from lead, copper, zinc and nickel dissolving therein is led to run through the metal adsorbent with amino group-having graft chains formed therein, thereby capturing the metal from the solution.

16. The metal capturing method as claimed in claim 15, wherein the solution with at least copper dissolving therein is led to run through the metal adsorbent having a crosslinked structure given to the graft chain therein, thereby selectively capturing copper from the solution.
